(19) United States
(12) Patent Application Publication
(10) Pub. No.: US 2023/0166329 A1
(43) Pub. Date: Jun. 1, 2023

(54) INTERMITTENT MATERIAL-TOOL INTERACTION CONTROL ENABLING CONTINUOUS DEPOSITION OF SOLID METAL VOXELS USING LOCAL HIGH-FREQUENCY, SMALL-DISPLACEMENT OSCILLATORY STRAIN ENERGY

(71) Applicant: Keng Hsu, Phoenix, AZ (US)

(72) Inventor: Keng Hsu, Phoenix, AZ (US)

(21) Appl. No.: 18/071,007

(22) Filed: Nov. 29, 2022

Related U.S. Application Data
(60) Provisional application No. 63/284,735, filed on Dec. 1, 2021.
(60) Provisional application No. 63/289,999, filed on Dec. 15, 2021.
(60) Provisional application No. 63/307,197, filed on Feb. 7, 2022.

(51) Int. Cl. B22F 10/22; B22F 10/38; B33Y 10/00; B33Y 30/00; B22F 12/50

(52) U.S. Cl. CPC B22F 10/22; B22F 10/38; B33Y 10/00; B33Y 30/00; B22F 12/50; B22F 2203/11

(57) ABSTRACT

An intermittent material-tool interaction control enabling continuous deposition of solid metal voxels using local high-frequency, small-displacement oscillatory strain energy, and methods of use are presented. The present disclosure provides for a new type of manufacturing and method of additive manufacturing different from conventional three dimensional printing still capable of producing production-level parts. Furthermore, the present disclosure provides a system and method for producing production-level quality parts of metal and the like, previously incapable in the state of the art or of extreme difficulty and expense.

### FIELD OF THE DISCLOSURE

This disclosure relates to an intermittent material-tool interaction control enabling continuous deposition of solid metal voxels using local high-frequency, small-displacement oscillatory strain energy. More specifically, and without limitation, the present disclosure relates to systems and methods for additive manufacturing techniques. More specifically, and without limitation, the present disclosure relates to methods for introducing intermittent material-tool contact to allow continuous deposition of material voxel in solid state from a wire feedstock in an additive manufacturing process.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright Reverb Industrial. All rights reserved.

### BACKGROUND OF THE DISCLOSURE

Three dimensional printing has grown in popularity in recent times. Various attempts have been made in utilizing three dimensional printing in manufacturing. Currently, in additive manufacturing approaches that use a depositing nozzle (or tool), when a layer of material is being deposited, the tool follows a continuous path while maintaining a constant distance with the substrate or an existing layer. The tool travels in the build-direction (Z-direction in 3-axis 3D printing), or in a direction not necessarily in the z-direction but orthogonal to an existing layer (in multi-axis printing) only when: 1) the movement to the next layer is needed, 2) non-deposition moves are being made by the tool, typically to avoid collision with the material that has already been deposited.

Unfortunately, current three dimensional printing techniques have proven to be very difficult in a manufacturing setting; many problems and long-felt needs plague this art. One reason for this is that current three dimensional printing techniques generally only work when applied to particular plastics or similar material. Conventional three dimensional printing techniques require a powder and binder or are molten material which is laid in a constant flow of liquid in a controlled pattern.

This path of a constant stand-off height from an existing surface followed by the tool does not allow for voxel-by-voxel material deposition-based additive manufacturing using local high-frequency, small-displacement oscillatory strain energy, or other contact-based additive manufacturing processes. Thus, the present disclosure provides for a new type of manufacturing and method of additive manufacturing different from conventional three dimensional printing still capable of producing production-level parts. Furthermore, the present disclosure provides a system and method for producing production-level quality parts of metal and the like, previously incapable in the state of the art or of extreme difficulty and expense.

The disclosure herein provides these advantages and others as will become clear from the specification and claims provided.

### SUMMARY OF THE DISCLOSURE

An intermittent material-tool interaction control enabling continuous deposition of solid metal voxels using local high-frequency, small-displacement oscillatory strain energy, and methods of use are presented. More specifically, and without limitation, the present disclosure relates to systems and methods for additive manufacturing techniques. More specifically, and without limitation, the present disclosure relates to methods for introducing intermittent material-tool contact to allow continuous deposition of material voxel in solid state from a wire feedstock in an additive manufacturing process.

Furthermore, the present disclosure provides for additive manufacturing processes where local high-frequency (1 kHz-1 MHz), small displacement (0.1 microns-100 microns) oscillatory strain is used. The strain is induced by the linear oscillatory movements in the tool which is in direct contact with the material to be deposited. The tool disclosed herein transfers the kinetic energy into the material in the form of oscillatory strain energy. The voxel of material is caused to come in direct contact with the tool. This strain energy enables the forming of this voxel into the desired shape and the enhanced diffusion of material across the interface with the material voxel and its adjacent surfaces to establish a desired composition by actively re-distribution and increase in crystalline dislocation density.

Furthermore, the present disclosure provides for a system and methods for efficiently transferring the oscillatory movement into the desired material. Complicating matters further, in order to efficiently transfer the oscillatory movement of the tool into the material voxel as oscillatory strain energy, the tool has to maintain sufficient physical contact with the material during deposition of a voxel.

In known methods of additive manufacturing printing, the constant tool-contact causes issues in using both oscillatory and static strains to achieve voxel shaping and joining. This tool-material contact introduces a linear frictional component of force along the direction in which the tool travels, continuously during printing. This frictional force transfers into the material as a linear strain along the direction in which the tool travels. This additional linear strain causes the material voxel to deform in both directions parallel with and perpendicular to the direction in which the tool travels, and results in voxel material fracture below the tool.

Thus, an effective method (such as the intermittent material-tool contact system and methods disclosed herein) to isolate and eliminate the linear strain along the tool travel direction in the voxel during a voxel deposition step is provided, and to ensure the total crystalline dislocation density remain controllably low to avoid brittle behaviors in printed parts. The present disclosure provides a unique system and method for three dimensional printing that enables manufacture of heavy duty parts and/or parts made of metal, for the first time. The system and methods provide a novel approach which enables voxel-by-voxel deposition of material to form continuous tracks and layers of material in voxel-by-voxel material deposition-based additive manufacturing using local high-frequency, small-displacement oscillatory strain energy.

Thus, the present disclosure provides for a novel system and method for deposition of materials to form objects; especially materials such as metal which were previously unavailable, or very difficult, in three dimensional printing. Furthermore, the present disclosure provides for a unique system and method for voxel-by-voxel deposition.

Thus, the primary object of the present disclosure is to provide a novel voxel-by-voxel material deposition system and method of use.

Yet another object of the disclosure is to provide voxel-by-voxel material deposition based additive manufacturing.

Another object of the disclosure is to provide a system and method of material deposition utilizing local high frequency, small displacement, oscillatory strain energy.

Another object of the disclosure is to provide an intermittent material-tool interaction control enabling continuous deposition of solid metal voxels using local high-frequency, small-displacement oscillatory strain energy, and heat.

Yet another object of the disclosure is to provide an intermittent material-tool interaction control enabling continuous deposition of solid metal voxels using local high-frequency, small-displacement oscillatory strain energy, and heat, and methods of use that provides intermittent material tool interaction control to produce continuous tracks of deposited metal voxels with controllably low crystalline dislocation density.

Another object of the disclosure is to provide an intermittent material-tool interaction control enabling continuous deposition of solid metal voxels using local high-frequency, small-displacement oscillatory strain energy, and heat, and methods of use that produces continuous tracks of deposited metal voxels with controllably low crystalline dislocation density through compression of the material and application of the oscillatory strain energy by the oscillatory movements of the tool.

Yet another object of the disclosure is to provide an intermittent material-tool interaction control enabling continuous deposition of solid metal voxels using local high-frequency, small-displacement oscillatory strain energy, and methods of use that provides for compression of the voxel with controllably low crystalline dislocation density before the application of oscillatory strain energy (“step and print mode”).

Another object of the disclosure is to provide an intermittent material-tool interaction control enabling continuous deposition of solid metal voxels using local high-frequency, small-displacement oscillatory strain energy, and methods of use that provides for compression of the voxels with controllably low crystalline dislocation density material in a continuous manner such that the tool moves through path steps (or “continuous mode”).

These and other objects, features, or advantages of the present disclosure will become apparent from the specification and claims.

### BRIEF DESCRIPTION OF THE DRAWINGS

The drawings accompanying and forming part of this specification are included to depict certain aspects of the disclosure.

FIG. 1 is an illustration of application; the view showing one example of the system and method of use for intermittent material-tool contact; the view showing one example of use of the system and continuous method to produce continuous voxel-by-voxel deposition; the view showing compression and movement of tooling applying metal to a surface.

FIG. 2 is a schematic view; the view showing one example of the system and method of use for intermittent material-tool contact; the view showing one example of use of the system and continuous method to produce continuous voxel-by-voxel deposition; the view showing a continuous metal filament; the view showing a tool; the view showing a tool path; the view showing a deposition; the view showing heating and oscillatory strain being applied to the continuous metal wire; the view showing a table and a build plate.

FIG. 3 is a schematic illustration of examples of how another example of intermittent material-tool contact can be established and used to produce continuous voxel-by-voxel deposition, in accordance with the disclosure herein; the view showing raising the tool in a vertical direction, moving the tool horizontally to a next position, and moving the tool down vertically to perform a next voxel compression.

FIG. 4 is a schematic illustration; the view showing one example of the system and method of use for intermittent material-tool contact; the view showing one example of use of the system and continuous method to produce continuous voxel-by-voxel deposition; the view showing raising the tool in a vertical direction while simultaneously moving the tool horizontally to a next position, and moving the tool down vertically to perform a next voxel compression; forming a slanted direction path for raising the tool.

FIG. 5 is a schematic illustration; the view showing one example of the system and method of use for intermittent material-tool contact; the view showing one example of use of the system and continuous method to produce continuous voxel-by-voxel deposition; the view showing raising the tool in a vertical direction while simultaneously moving the tool horizontally to a next position, and lowering the tool down vertically while simultaneously moving the tool horizontally to perform a next voxel compression; forming a slanted direction path for raising the tool and compressing a subsequent voxel.

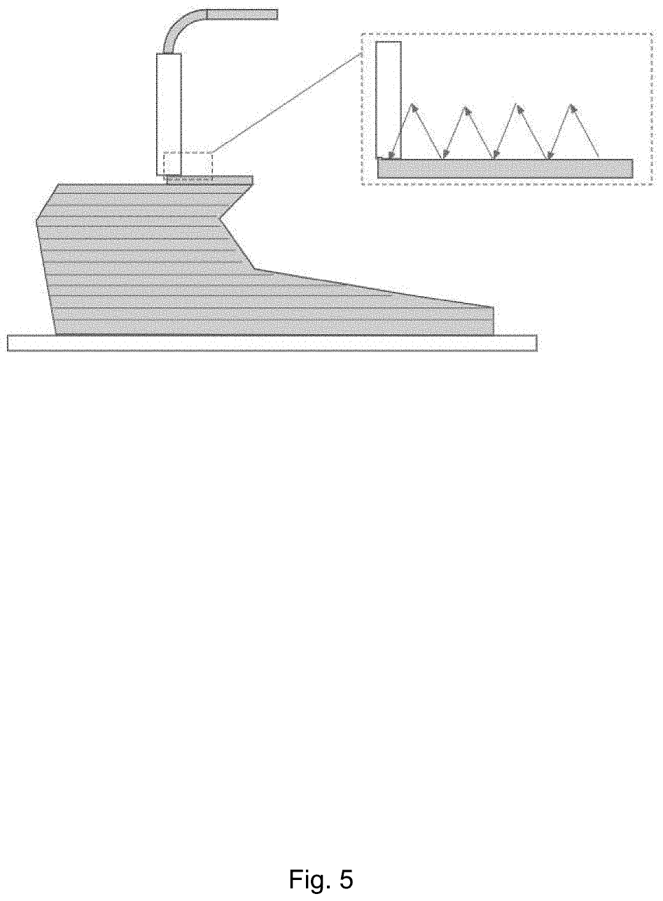

FIG. 6 is a schematic illustration; the view showing one example of the system and method of use for intermittent material-tool contact; the view showing one example of use of the system and continuous method to produce continuous voxel-by-voxel deposition; the view showing; the view showing raising the tool in a vertical direction; the view showing lowering the tool down vertically while simultaneously moving the tool horizontally to perform a next voxel compression; forming a slanted direction path for raising the tool and compressing a subsequent voxel.

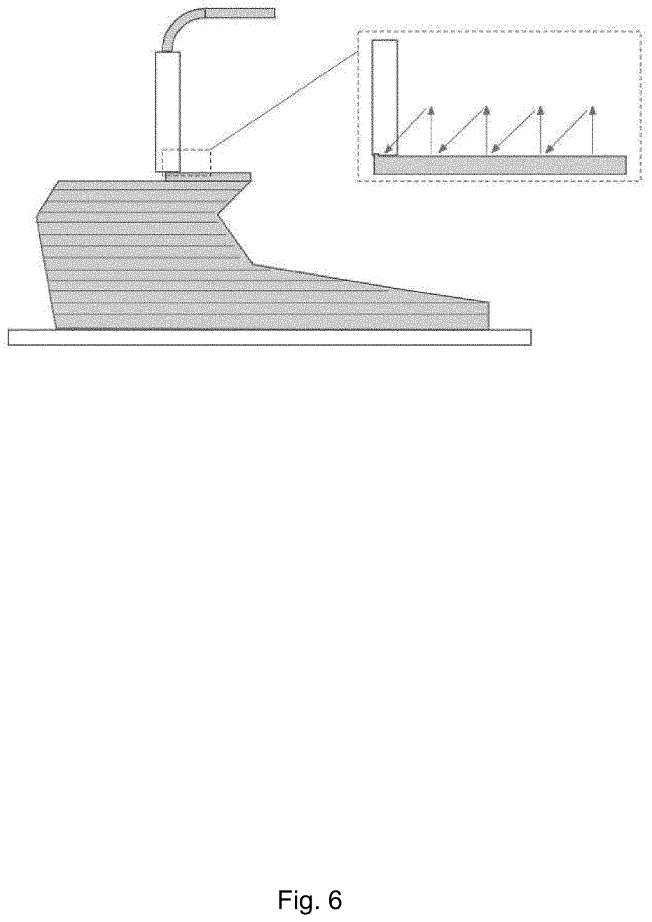

FIG. 7 is an illustration showing one example of an embodiment of the method of use and tool path; the view showing a square-wave path.

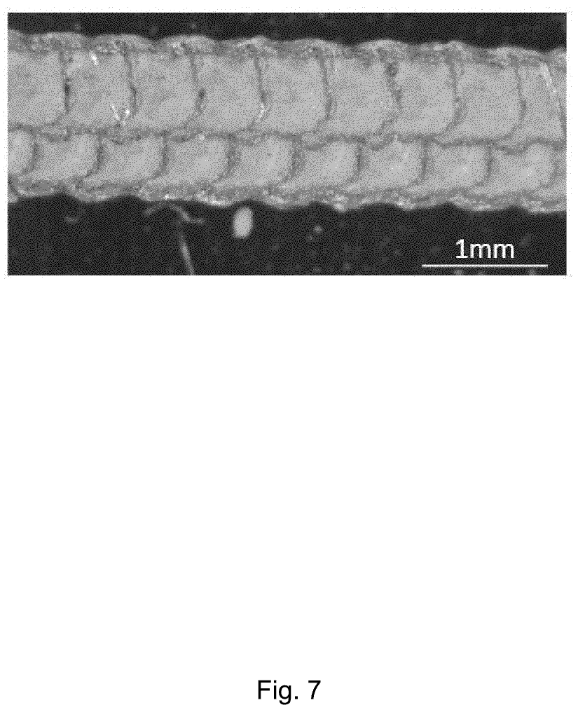

FIG. 8 is an illustration showing one example of an embodiment of the method of use and tool path; the view showing an inverted saw-tooth path.

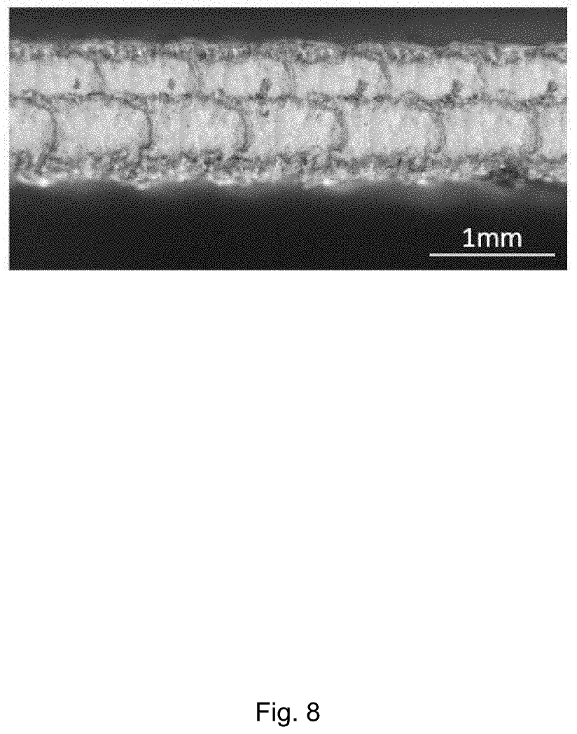

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

### System and Methods of Use

In the arrangement shown, as one example, an intermittent material-tool interaction control enabling continuous deposition of solid metal voxels using local high-frequency, small-displacement oscillatory strains, and methods of use are presented, or simply referred to herein as system 1. System 1 also includes, in the arrangement shown as one example, two methods (or “modes”) of intermittent material-tool interaction control to produce continuous tracks of deposited metal voxels with local high-frequency, small amplitude oscillatory strain, which is implemented in the aspect of the sequence of compression of a voxel by a tool and application of oscillatory strain energy by the oscillatory movements of the tool. In one mode, the voxel is compressed first before the application of oscillatory strain energy. This mode herein is referred to as the “Step-And-Print” mode. In the other mode, the oscillatory movement in the tool is kept on while the tool moves through its path steps; this second mode of operation is referred to as the “Continuous” mode.

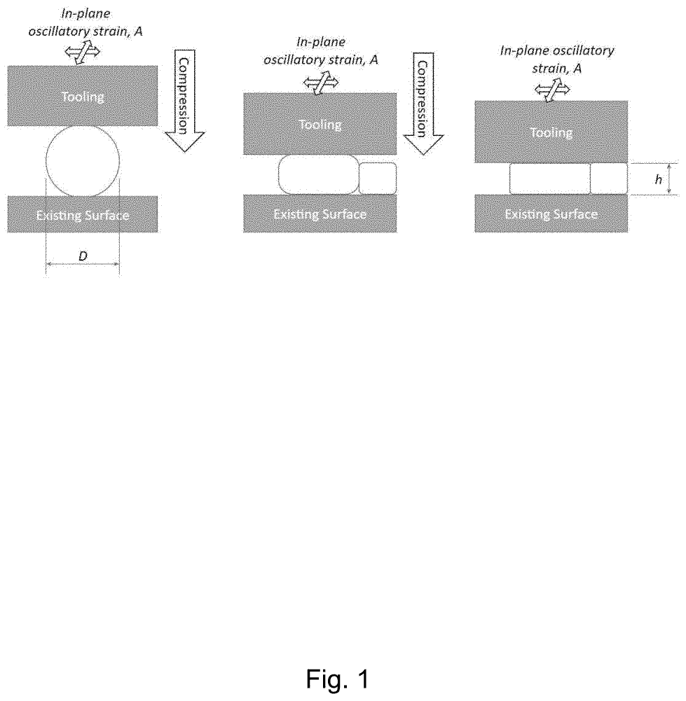

With reference to FIG. 1, as one example, a system 1 for using the Step-and-Print mode is disclosed. System 1, also referred to as a platform 10 is provided. Platform 10, on which a structure 90 is produced by successively depositing individual tracks 20 and layers 30 adjacently, and on top of each other, to additively manufacture the structure 90. The tracks are deposited voxel-by-voxel from a tool 50. In one example, the material fed into the tool 50 is a solid metal wire 40.

The tool control program is set up such that each voxel deposition cycle includes the following steps: tool 50 traverses laterally from a first position 70; tool moves downward 60 (also referred to as a “Z”, or “Z-direction”) and compresses the voxel in a pre-set-amount of compression; oscillatory strain energy irradiation starts, and turns off for a predetermined amount of time (can vary from milliseconds to tens of seconds depending on material and desired process characteristics). Said another way, in some examples the tool is compressed for milliseconds. In other examples, the tool 50 may be compressed for seconds. In another example, the tool 50 may be compressed for tens of seconds or longer. Upon completion of compression, tool 50 lifts up in Z-direction 60. This step cycle repeats as the tool 50 progresses in the path defined by the program. In the arrangement shown, as one example, a three-dimensional model (or a “3D model”) is built and/or sliced or is “sliced” into layers and tracks for metal deposition.

In one example, in the continuous mode of metal deposition, the step cycle does not include turning on and off oscillatory strain energy irradiation. While the tool 50 moves through the same physical movements as those of the Step-and-Print mode, the oscillatory strain energy is kept on the entire time. In this way, the oscillatory strain energy is only interrupted and/or stopped when desired by the user (or program design). Typically, the oscillatory strain energy is only stopped when desired or for other purposes, such as tool cleaning, etc.

Furthermore, in the Continuous mode, a primary advantage is that the voxel compression process becomes displacement controlled (as opposed to the force control in the Step-and-Print mode). The use of displacement-controlled voxel deposition brings about a number of new process characteristics.

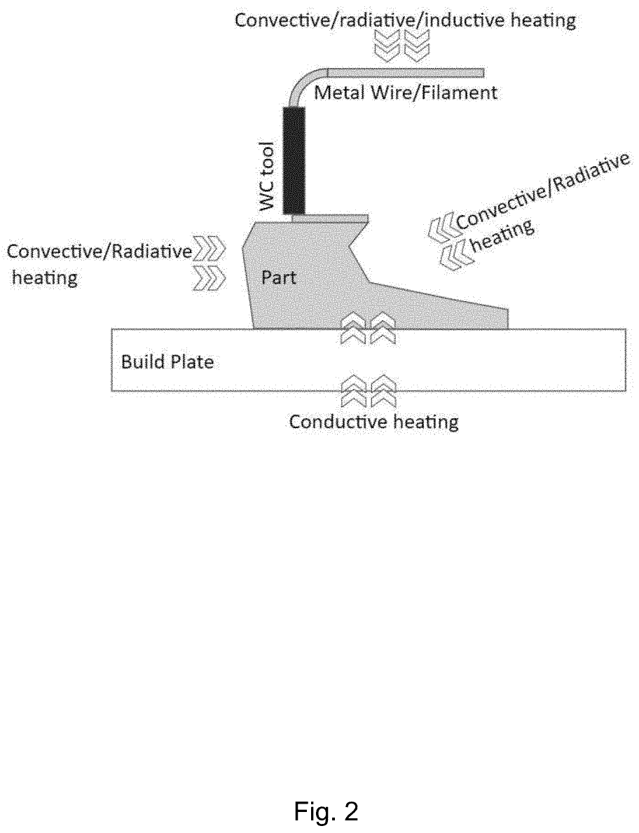

With reference to FIG. 2, as one example of a system 1 for using the Step-and-Print and continuous mode is presented. In the arrangement shown, as one example, a platform 10 is provided, on which a structure 90, is produced by successively depositing individual tracks 20 and layers 30 adjacently and on top of each other to additively manufacture the structure 90. The plurality of tracks 20 are deposited voxel-by-voxel from a tool 50. In one example, the material fed into the tool 50 is a solid metal wire 40.

In the arrangement shown, as one example, the tool control program is provided with a predetermined set of rules such that each voxel deposition cycle includes the following steps: tool 50 traverses up in Z direction 90 at an angle with respect to Z direction 90 from a first position to a second position. The tool 50 moves vertically down in second Z-direction 100 and compresses the voxel to a pre-set amount of compression. This step cycle repeats as the tool 50 progresses in the path defined by a slicer program in which a 3D model (to be built) is sliced into layers and tracks for metal deposition.

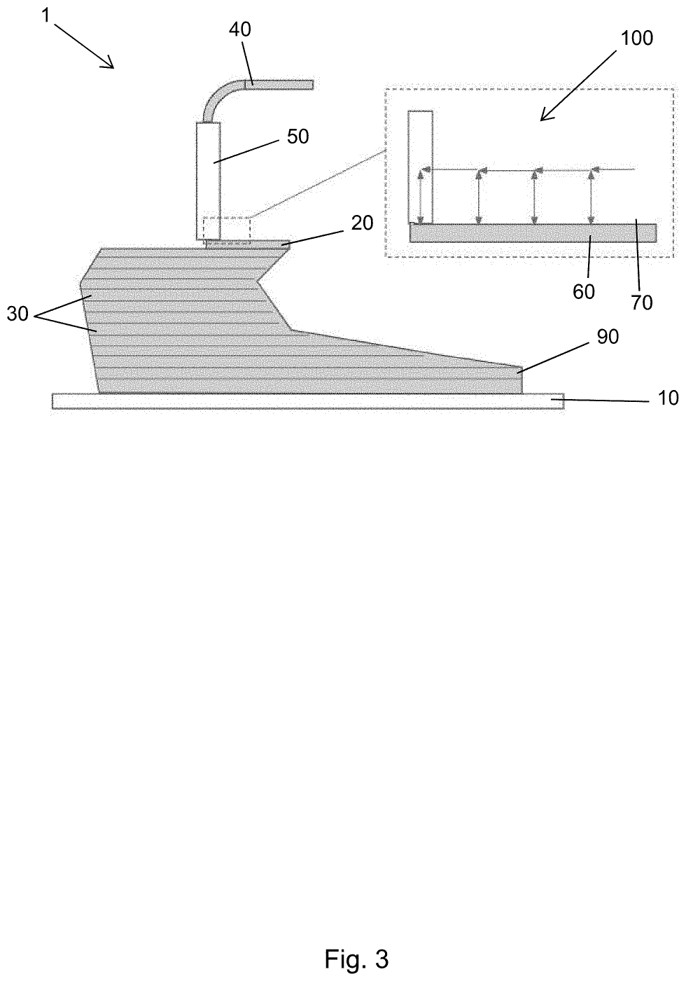

With reference to FIG. 3, in the arrangement shown as one example, a system 10 for using the Step-and-Print and continuous mode is disclosed. In the arrangement shown, as one example, system 1 is provided, upon which a structure 90 is produced by successively depositing individual tracks 20 and layers 30 of adjacent and on top of each other to additively manufacture the structure 90.

In the arrangement shown, as one example, the tracks are formed from voxel-by-voxel deposits from a tool 50. In one arrangement, the tool 50 is fed by a solid metal wire 40. The tool control program is set up such that each voxel deposition cycle includes the following steps: 1) Tool 50 moves to voxel dispension location, 2) Tool 50 deposits designated amount, 3) Tool 50 moves vertically a predetermined distance, 4) Tool 50 moves horizontally a predetermined distance, 5) Tool 50 moves downward vertically to cause second dispension. This process is repeated to create tracks. Tracks are repeated to make layers. Or, this process is repeated to make layers, then tracks. Furthermore, the tool 50 may move horizontally and vertically in a simultaneous motion such that the tool 50 appears to move in an arc or semicircle or other similar motion.

In the arrangement shown, voxel-by-voxel depositing is shown. Said another way, tool 50 traverses up in Z at an angle with respect to Z to the next X-Y position; tool moves down at an angle with respect with Z towards the x-y position of the next voxel and compresses the voxel to a pre-set amount of compression. This step cycle repeats as the tool progresses in the path defined by a slicer program in which a 3D model (to be built) is sliced into layers and tracks for metal deposition.

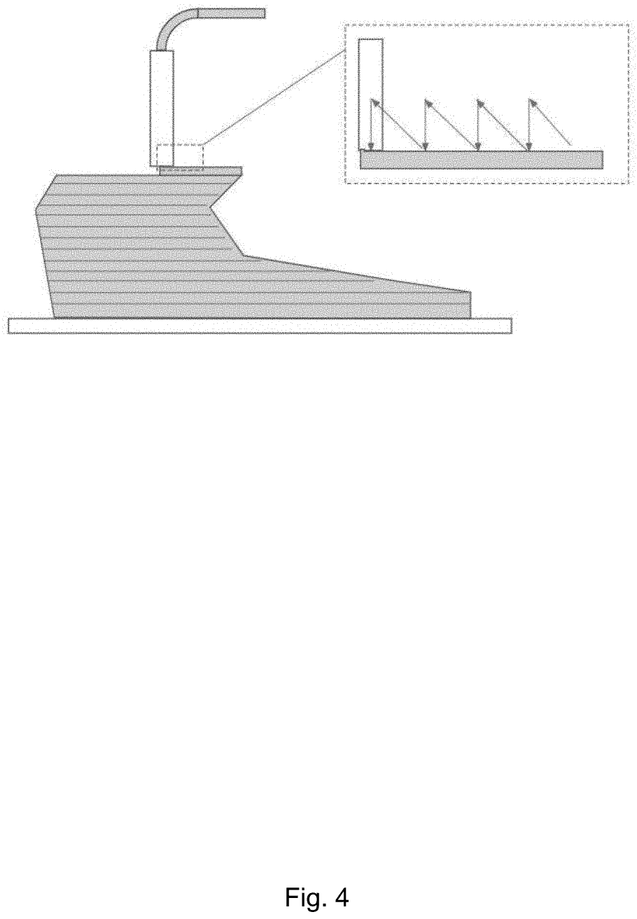

With reference to FIG. 4, in the arrangement shown as one example, system 1 provides for Step-and-Print and continuous mode of structure 90 creation through voxel-by-voxel dispension. Said another way, and in the arrangement shown, as one example, a platform 10 is provided, on which a structure 90 is produced by successively depositing voxel-by-voxel deposits to form individual tracks 20 and layers 30.

In the arrangement shown, as one example, the tracks 20 and layers 30 are created adjacently and on top of a previous to additively manufacture the structure 90. The tracks 20 are deposited voxel-by-voxel from a tool 50. In the arrangement shown, the deposits may be formed of a metal, a metal alloy, another similarly rigid material, a combination thereof, or the like.

The tool control program is set up such that each voxel deposition cycle includes the following steps: tool 50 traverses vertically up in Z; tool moves down at an angle with respect with Z towards the x-y position of the next voxel and compressed the voxel to a pre-set amount of compression. This step cycle repeats as the tool progresses in the path defined by a slicer program in which a 3D model (to be built) is sliced into layers and tracks for metal deposition.

In the arrangement shown, as one example, various deposition modes are contemplated for use. Each mode of deposition form results in slightly different process. Each process may have varying speeds at the voxel level. Furthermore, each deposition mode can lead to larger build time differences (build speed) in larger builds. In addition to speed, the bond quality can be modified depending on different deposition paths chosen and/or programmed. The filament diameter-compression-voxel geometry correlations have significant effect on voxel compression tolerance which can not only determine part dimension tolerance, as well as, whether the voxel compression at each layer stays within the process window to allow a build to continue.

In one arrangement and methodology disclosed herein, furthermore with respect to the continuous mode methodology, the voxel geometry and dimension can be more confined and closely linked to the tooling motion disclosed and described herein. In this way, the present disclosure not only provides a novel deposition, but the deposition can be more controlled and/or improved through geometry and motion of the geometry.

Furthermore, and in one method, a conversion from a square-wave path to any of a number of the non-orthogonal paths is available. This conversion can result in process speed change. It can also result in the changes in the mechanics of voxel compression/deposition, and therefore change the geometry and tolerances of the process. In the arrangement shown, voxels made using the square wave path have the same thickness as those made with non-orthogonal paths. However, the geometry of square-wave path voxels in the x-y (build plane) direction exhibit more isotropic shapes as compared with those made with non-orthogonal paths. In the arrangements shown, as one example, the voxels deposited using square-wave path are more square-like as opposed to the rectangular shaped voxels, which results from an inverted saw-tooth path.

These variations in configuration of system 1 are just some of the examples of variations disclosed and available. These examples, and variations available in voxel geometry translate into a few key differences in the part characteristics. First, the side surface “scalloping” effect in the track direction is smaller with a non-orthogonal path, whereas the square-wave path creates parts with a “wavy” surface feature in the track direction. Second, the width of the tracks made using the square-wave path is wider because of the geometry of the voxels in the build-plane direction.

In the arrangement shown, as one example, two-track walls are built using two different paths. These two track walls differ by about 15-20%. In other words, if a user chooses to exercise the non-orthogonal path option disclosed herein, the feature resolution of deposition is higher, and the minimal feature size is smaller. This is one of the many options and features disclosed herein and may be desired in some applications.

In the arrangement shown, as one example, the metal property is very consistent through a voxel deposition step. Furthermore, and in the arrangement shown as one example, the oscillatory strain energy irradiation is constant from initiation of tool-feedstock contact to the end of the compression/deposition cycle. Said another way, the oscillatory strain energy irradiation is constant before the tool 50 lifts from the deposited voxel. In this way, the amount of voxel material softening in the voxel remains consistent (given that the power output from oscillatory strain energy generator is in amplitude tracking mode). In this way, the present disclosure provides for a more stable process, and better compression control. Furthermore, the present disclosure also provides for dynamic recovery control in the voxel. In this way, the present disclosure also provides for methods which includes better property control of deposited material.

The present disclosure also provides for, in one arrangement, consistent compression stress and strain rate throughout the compression cycle. In one arrangement, as is shown, tool 50 provides the same resistance to its motion throughout the compression step, and the amount of voxel softening remains constant. In this way, the material strain rate remains the same. In this way, the “microstructure evolution” history in the voxel, as it is being compressed and deposited, remains consistent. In this way, the present disclosure provides for less variation during deposition because the method disclosed herein provides for consistent load on the tool 50 during the deposition process. In this way, the present disclosure also provides for better tool life than would be expected.

As another benefit of the present disclosure, and in the arrangement shown, as one example, the physical steps of turning on and/or off of the oscillatory strain energy source is eliminated. In this way, the present disclosure provides for a decreased time in the voxel deposition cycle. In this way, the present disclosure provides for an increase in overall process speed than would be expected.

In another aspect, and disclosed herein, the continuous mode disclosed herein results in a build speed 10 times faster than expected. This is a conservative measure. In the arrangement shown, as one example, the build speed is accelerated by 10 times. In this way, the present disclosure provides for increased yield of the interface bond to over 90% at each voxel, as compared with the Step-and-Print mode. In the arrangement shown, and particularly in the continuous mode, as one example, the ultrasonic vibration in the tooling system is kept on. In the arrangement shown, by keeping the ultrasonic vibration on, the tool 50 rapidly steps through the print path without any pauses. In this way the oscillatory strain energy input is kept on, increasing the voxel compression rate by a factor or 15-20 from around 1 mm/s to around 20 mm/s. In this way, the present disclosure significantly increases the yield of voxel-voxel bonding, as well as track-track and layer-layer bonding.

In the arrangement and discussions herein, “E” represents a numerical value. As one example, A is greater than or equal to E*D and less than or equal to 5 times E*D or 10*E*D, and the like. These ranges are narrowed and other ranges are hereby contemplated for use. As another example, E may be anywhere between 0.001 and 0.003. Said another way, E may be between 0.1% and 0.3% or 0.01% and 0.5%, or 0.001% and 0.99%, and the like.

In addition to the above identified features, options, controls, and components, system 10 may also include other features and functionalities, among other options, controls, and components.

Furthermore, it will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A method of printing a three-dimensional object using a continuous metal feedstock, the steps comprising:
providing a tool;
providing a metal substrate;
providing a drive to feed the continuous metal feedstock;
applying heat to the metal substrate;
applying an oscillatory strain along a filament;
compressing the continuous metal feedstock in a direction orthogonal to the filament, forming the voxel to a height;
raising the tool while the continuous metal feedstock is fed through the tool;
repeating the application for a plurality of voxels to form a tool path.

2. The method of claim 1, further comprising:
applying heat to the metal substrate such that a voxel temperature is greater than 25% of a melting temperature of the continuous metal feedstock but less than 95% of the melting temperature of the continuous metal feedstock.

3. The method of claim 1, further comprising:
applying the oscillatory strain along the filament in an axial direction at a strain amplitude in a range consisting of:
wherein the strain amplitude is greater than E*D; and
wherein the strain amplitude is less than 5*E*D; and
wherein E is a numerical value between 0.001 and 0.003;
wherein D is a diameter of the continuous metal feedstock.

4. The method of claim 1, further comprising:
applying the oscillatory strain along the filament in an axial direction at a strain amplitude in a range consisting of:
wherein the strain amplitude is greater than E*D; and
wherein the strain amplitude is less than 5*E*D; and
wherein E is a numerical value between 0.001 and 0.003;
wherein D is a cross-sectional height of a voxel.

5. The method of claim 1, further comprising:
applying the oscillatory strain along the filament in an axial direction at a strain amplitude in a range consisting of:
wherein the strain amplitude is greater than E*D; and
wherein the strain amplitude is less than 5*E*D; and
wherein E is a numerical value between 0.0001 and 0.1;
wherein D is a diameter of the continuous metal feedstock.

6. The method of claim 1, further comprising:
applying the oscillatory strain along the filament in an axial direction at a strain amplitude in a range consisting of:
wherein the strain amplitude is greater than E*D; and
wherein the strain amplitude is less than 5*E*D; and
wherein E is a numerical value between 0.0001 and 0.1;
wherein D is a cross-sectional height of a voxel.

7. The method of claim 1, further comprising:
applying the oscillatory strain along the filament in an axial direction at a strain amplitude in a range consisting of:
wherein the strain amplitude is greater than E*D; and
wherein the strain amplitude is less than 5*E*D; and
wherein E is a numerical value between 0.0001 and 0.99;
wherein D is a diameter of the continuous metal feedstock.

8. The method of claim 1, further comprising:
applying the oscillatory strain along the filament in an axial direction at a strain amplitude in a range consisting of:
wherein the strain amplitude is greater than E*D; and
wherein the strain amplitude is less than 5*E*D; and
wherein E is a numerical value between 0.0001 and 0.99;
wherein D is a cross-sectional height of a voxel.

9. The method of claim 1, further comprising:
wherein the height divided by D is between 0.75 and 0.1;
wherein compressing the continuous metal feedstock occurs while applying the oscillatory strain and heat.

10. The method of claim 1, further comprising:
wherein the height divided by D is between 0.99 and 0.001;
wherein compressing the continuous metal feedstock occurs while applying the oscillatory strain and heat.

11. The method of claim 1, further comprising:
repeating the application of a plurality of voxels to form a track of a desired length;
repeating the application for the plurality of voxels to form a three-dimensional object.

12. The method of claim 1, further comprising:
controlling a side-wall roughness of a printed object, using the tool path.

13. The method of claim 1, further comprising:
raising the tool in a vertical direction, moving the tool horizontally to a next position, and moving the tool down vertically to perform a next voxel compression.

14. The method of claim 1, further comprising:
raising the tool in a vertical direction while simultaneously moving the tool horizontally to a next position, and moving the tool down vertically to perform a next voxel compression; forming a slanted direction path for raising the tool.

15. The method of claim 1, further comprising:
raising the tool in a vertical direction while simultaneously moving the tool horizontally to a next position, and lowering the tool down vertically while simultaneously moving the tool horizontally to perform a next voxel compression; forming a slanted direction path for raising the tool and compressing a subsequent voxel.

16. A method of printing a three-dimensional object using a continuous metal feedstock, the steps comprising:
providing a tool;
providing a metal substrate;
providing a drive to feed the continuous metal feedstock;
applying heat to the metal substrate such that a voxel temperature is greater than 25% of a melting temperature of the continuous metal feedstock but less than 95% of the melting temperature of the continuous metal feedstock;
applying an oscillatory strain along a filament in an axial direction at a strain amplitude in a range consisting of:
wherein the strain amplitude is greater than E*D; and
wherein the strain amplitude is less than 5*E*D; and
wherein E is a numerical value between 0.001 and 0.003;
wherein D is a diameter of the continuous metal feedstock or wherein D is a cross-sectional height of a voxel;
compressing the continuous metal feedstock in a direction orthogonal to the filament, forming the voxel to a height;
wherein the height divided by D is between 0.75 and 0.1;
wherein compressing the continuous metal feedstock occurs while applying the oscillatory strain and heat;
raising the tool while the continuous metal feedstock is fed through the tool;
repeating the application of a plurality of voxels to form a track of a desired length;
repeating the application for a plurality of voxels to form a three-dimensional object;
repeating the application for a plurality of voxels to form a tool path;
controlling a side-wall roughness of a printed object, using the tool path.

17. The method of claim 16, further comprising:
raising the tool in a vertical direction, moving the tool horizontally to a next position, and moving the tool down vertically to perform a next voxel compression;

18. The method of claim 16, further comprising:
raising the tool in a vertical direction while simultaneously moving the tool horizontally to a next position, and moving the tool down vertically to perform a next voxel compression; forming a slanted direction path for raising the tool;

19. The method of claim 16, further comprising:
raising the tool in a vertical direction while simultaneously moving the tool horizontally to a next position, and lowering the tool down vertically while simultaneously moving the tool horizontally to perform a next voxel compression; forming a slanted direction path for raising the tool and compressing a subsequent voxel.

20. A system for producing a three-dimensional tool path, the system comprising:
a print head that is movable in one or more dimensions and is configured to feed a solid metal wire for subsequently forming each layer of the three-dimensional structure, the metal voxel being formed from a solid metal wire.

21. The system of claim 20, further comprising:
wherein the tool, in one voxel deposition cycle, moves by combining up, down, and lateral motions to produce a vertical voxel compression movement.

22. The system of claim 20, further comprising:
wherein the tool, in one voxel deposition cycle, moves by combining up, down, and lateral motions to produce an angled voxel compression movement with respect to the z-axis.

23. The system of claim 20, further comprising:
wherein the tool, in one voxel deposition cycle, moves by combining up, down, and lateral motions to produce an angled tooling lifting movement with respect to the z-axis.

24. The system of claim 20, further comprising:
wherein the tool, in one voxel deposition cycle, moves by combining up, down, and lateral motions to produce an angled tooling lifting movement and voxel compression movement with respect to the z-axis.
